(19) United States
(12) Patent Application Publication
(10) Pub. No.: US 2024/0288744 A1
(43) Pub. Date: Aug. 29, 2024

(54) ELECTRO-OPTICAL MODULATOR

(71) Applicants: SMART PHOTONICS HOLDING B.V., Eindhoven (NL); NEDERLANDSE ORGANISATIE VOOR WETENSCHAPPELIJK ONDERZOEK (NWO), Den Haag (NL); TECHNISCHE UNIVERSITEIT EINDHOVEN, Eindhoven (NL)

(72) Inventor: Arezou MEIGHAN, Eindhoven (NL)

(21) Appl. No.: 18/658,831

(22) Filed: May 8, 2024

Related U.S. Application Data
(63) Continuation of application No. PCT/EP2022/081166, filed on Nov. 8, 2022.

(30) Foreign Application Priority Data
Nov. 9, 2021 (GB) 2116110.4

(51) Int. Cl. G02F 1/225

(52) U.S. Cl. CPC G02F 1/2257; G02F 2201/12

(57) ABSTRACT

An electro-optical modulator for a photonic integrated circuit. The electro-optical modulator comprising: a substrate; a first waveguide on a first portion of the substrate; a first electrode; a second waveguide on a second portion of the substrate; and a second electrode. A first electrical impedance value between the first electrode and the second electrode is different from a second electrical impedance value between the first electrode and the second electrode. The first electrical impedance value along a first axis perpendicular a light propagation axis of the first waveguide. The second electrical impedance value along a second axis perpendicular the light propagation axis of the first waveguide. The first axis spaced from the second axis along the light propagation axis of the first waveguide.

### CROSS-REFERENCE TO RELATED APPLICATIONS

This application is a continuation under 35 U.S.C. § 120 of International Application No. PCT/EP2022/081166, filed Nov. 8, 2022 which claims priority to United Kingdom Application No. GB 2116110.4, filed Nov. 9, 2021 under 35 U.S.C. § 119(a). Each of the above-referenced patent applications is incorporated by reference in its entirety.

### BACKGROUND

Electro-optical modulators are used to modulate the intensity of an optical signal by applying an electrical signal. This allows the conversion of electrical signals into optical signals, for example for optical communications systems and optical systems. Faster modulation of optical signals can allow more accurate optical data transmission and higher rates of optical data transmission.

Semiconductor structures can be used in photonic integrated circuits (PICs) to perform various functions. It is desirable to provide an improved electro-optical modulator for a PIC.

### BRIEF DESCRIPTION OF THE DRAWINGS

FIG. 1 shows schematically a cross-section view at plane 100A and a cross-section view at plane 100B of parts of an example electro-optical modulator in accordance with examples.

FIG. 2 shows schematically a plan view of the parts of the electro-optical modulator of FIG. 1.

FIG. 3 shows schematically a side-view of the parts of the electro-optical modulator of FIG. 1.

FIG. 4 shows schematically a cross-section view at plane 400A and a cross-section view at plane 400B of parts of an example electro-optical modulator in accordance with further examples.

FIG. 5 shows schematically a plan view of the parts of the electro-optical modulator of FIG. 4.

FIG. 6 shows schematically a side-view of the parts of the electro-optical modulator of FIG. 4.

FIG. 7 shows schematically a cross-section view at plane 700A and a cross-section view at plane 700B of parts of an example electro-optical modulator in accordance with further examples.

FIG. 8 shows schematically a plan view of the parts of the electro-optical modulator of FIG. 7.

FIG. 9 shows schematically a side-view of the parts of the electro-optical modulator of FIG. 7.

FIGS. 10 to 13 shows schematically cross-section views of parts of different electro-optical modulators in accordance with different examples.

FIG. 14 shows schematically application of potential differences in accordance with examples.

FIG. 15 shows schematically a plan view of a photonic integrated circuit in accordance with examples.

FIG. 16 shows schematically a plan view of photonic integrated circuit in accordance with further examples.

FIG. 17 shows schematically a plan view of a system for electro-optical modulation in accordance with examples.

FIG. 18 illustrates a method of modulating an optical signal in accordance with examples.

FIG. 19 illustrates a method of manufacturing an electro-optical modulator in accordance with examples.

FIG. 20 illustrates schematically an electro-optical modulator with a coplanar waveguide (CPW) configuration, according to further examples.

FIG. 21 illustrates schematically an electro-optical modulator with a capacitively loaded (CL) configuration, according to further examples.

### DETAILED DESCRIPTION

In examples to be described, an electro-optical modulator is configured such that an electrical impedance value is different at different locations along a light propagation axis of one or more waveguides. In so doing, the electro-optical modulator can function both for example as a Mach-Zehnder modulator (MZM) (explained further below) and also to change the electrical impedance value along the light propagation axis, e.g. so that the input electrical impedance value is different from the output electrical impedance value. Hence, compared with known systems using a separate component for changing the electrical impedance of the output from an MZM, a PIC of examples described herein can be smaller, e.g. its foot-print on a substrate, because the electro-optical modulator has such a dual functionality.

Examples described herein relate to an electro-optical modulator for use in a PIC. More specifically, examples described herein comprise a semiconductor structure for modulation of an optical signal in response to an electrical signal. Modulating a difference in effective optical path length between a first waveguide and a second waveguide of the modulator, and combining and interfering the output from each waveguide, allows the modulation of the intensity of the output due to constructive and destructive interference. Modulating the difference in effective optical path length between the first waveguide and the second waveguide is achieved by modulating a difference between a potential difference applied across the first waveguide and a potential difference applied across the second waveguide, due to the electro-optical effect. In some examples the electro-optical modulator is a Mach-Zehnder modulator. Mach-Zehnder modulators give fast modulation speed and large optical extinction.

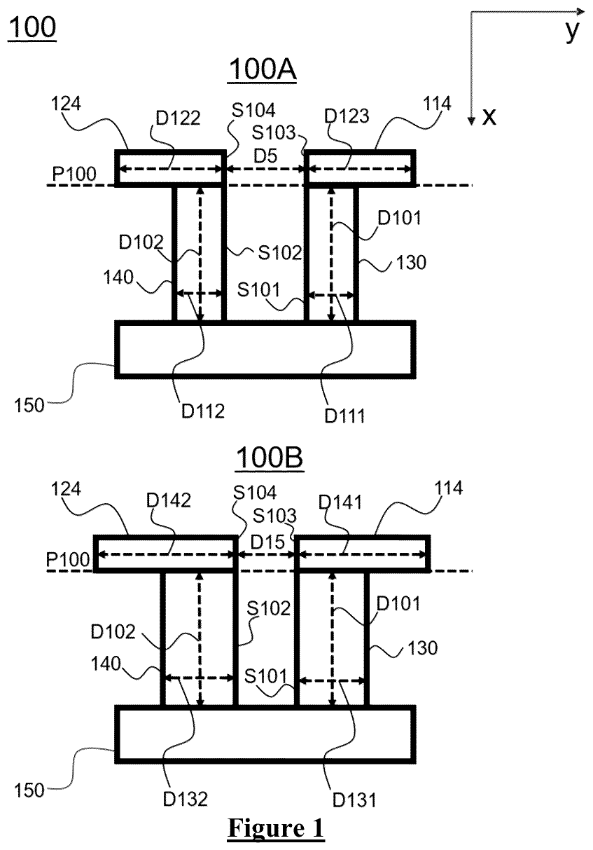

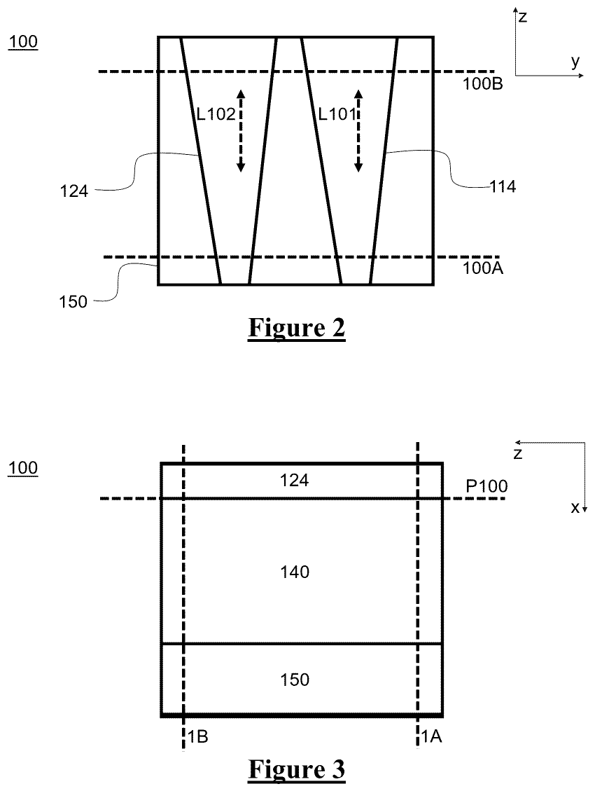

By way of general introduction to examples described herein, and with reference to FIGS. 1 to 3, an electro-optical modulator 100 for a PIC comprises: a substrate 150; a first waveguide 130 on a first portion of the substrate; a second waveguide 140 on a second portion of the substrate; a first electrode 114; and a second electrode 124. A first electrical impedance value between the first electrode and the second electrode is different from a second electrical impedance value between the first electrode and the second electrode. The first electrical impedance value is along a first axis (for example an axis on plane 100A) perpendicular a light propagation axis L101 of the first waveguide L101, and the second electrical impedance value is along a second axis (for example an axis on plane 100B) perpendicular the light propagation axis L101 of the first waveguide L101. The first axis is spaced from the second axis along the light propagation axis L101 of the first waveguide 130. In some examples the first electrical impedance value is greater than the second electrical impedance value, and in other examples the first electrical impedance value is less than the second electrical impedance value. The electrical impedance value may be taken or is measurable, along the corresponding axis, and a person skilled in the art will appreciate how to measure, predict or model an electrical impedance value. In examples, the electro-optical modulator is configured so that the electrical impedance value between the first electrode and the second electrode at the input of the first waveguide and the input of the second waveguide respectively is different to, e.g. greater or less than, the electrical impedance value between the first electrode and the second electrode at the output of the first waveguide and the output of the second waveguide respectively. Some such examples are illustrated by FIGS. 1 to 3, and corresponding reference numerals are given earlier in this paragraph, but it is to be appreciated that at least some features described in relation to FIGS. 1 to 3 apply also to further examples described later.

It is to be understood that a person skilled in the art will: express an electrical impedance value as a complex number; express the magnitude of an electrical impedance value as a real number; and use the unit of Ohms (Ω) for both electrical impedance values and the magnitude of electrical impedance values. In some examples, the magnitude of the first electrical impedance value is different to the magnitude of the second electrical impedance value. As an electrical impedance value is expressed as a complex number, in other examples the first electrical impedance value is different from the second electrical impedance value but the magnitude of the first electrical impedance value is the same as the magnitude of the second electrical impedance value.

In some examples, both the first waveguide and the second waveguide each comprises an optical input and an optical output. Light at least partially propagates from the optical input to the optical output for each waveguide. In some examples for each optical input or optical output there is a portion of electrode corresponding to (e.g. located in the same plane as) the optical input and/or optical output portion of the waveguide. In some examples, the first electrical impedance value is between a portion of the first electrode corresponding to the optical input of the first waveguide and a portion of the second electrode corresponding to the optical input of the second waveguide. Similarly, the second electrical impedance value is between a portion of the first electrode corresponding to the optical output of the first waveguide and a portion of the second electrode corresponding to the optical output of the second waveguide.

The portion of the first electrode corresponding to the optical input of the first waveguide and the portion of the second electrode corresponding to the optical input of the second waveguide are, for example, electrode surfaces opposed to each other, in other words a portion of a surface of the first electrode facing or opposed to a portion of a surface of the second electrode. Similarly, the portion of the first electrode corresponding to the optical output of the first waveguide and the portion of the second electrode corresponding to the optical output of the second waveguide are for example, electrode surfaces opposed to each other. Such portions of the electrode surfaces can each be a point of the respective electrode surface; e.g. the portion of the first electrode is a surface point of the first electrode and the portion of the second electrode is a surface point of the second electrode.

In some examples, the first waveguide is between the first electrode and the first portion of the substrate, and so the first electrode can be considered for example to be part of a first stack of layers on the first portion of the substrate. This stack occupies a relatively small area, or footprint, on the substrate, which can contribute to a more compact modulator. Similar reasoning, for example, applies to the second electrode as part of what can be considered a second stack on the second portion of the substrate, further contributing to a more compact modulator. Further, with the electrodes on the waveguides as described, the two electrodes can be positioned closer to each other than in known examples, which can help for designing a modulator e.g. with a lower capacitance than known alternatives.

A person skilled in the art will appreciate that a waveguide is for guiding light. Light propagates within a waveguide and is confined within a waveguide due to reflection at the boundaries of the waveguide. A waveguide usually has a refractive index higher than the refractive index of material in contact with the waveguide at the boundaries at which confinement of light is desired. For example, due to this refractive index difference at the boundaries at which confinement of light is desired, total internal reflection takes place when the angle of incidence at these boundaries of the waveguide is greater than the critical angle. In this manner, a waveguide guides the propagation of the light. For a particular optical mode to propagate in the waveguide, it is desired that the light reflected at the boundaries of the waveguide fulfils the conditions for constructive interference.

Examples will now be described in detail. Note that, some features (e.g. portions, axes and others) are referred to, for example, as a first, a second, or a third, etc. feature. This labelling convention is used for clarity, to help distinguish between different features and does not necessarily indicate the number of such feature present in an example For example, a third portion, can be referred to without necessarily implying the existence also of a first portion and a second portion.

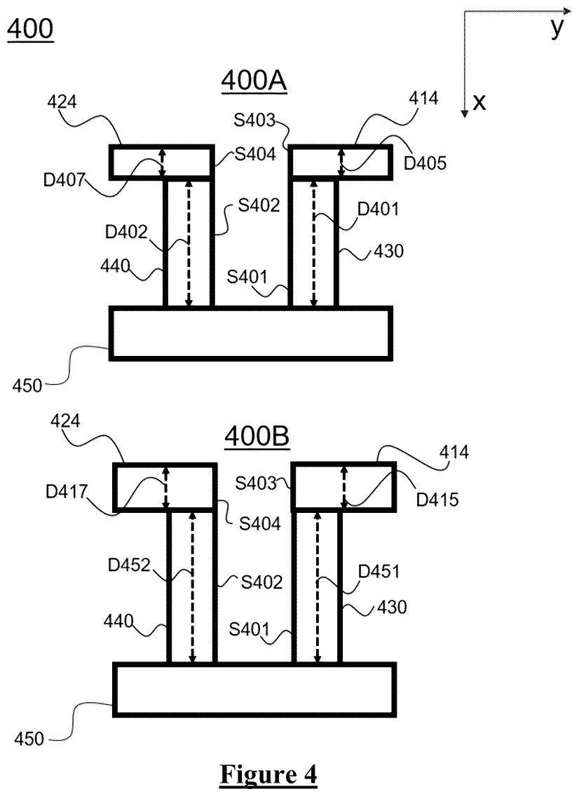

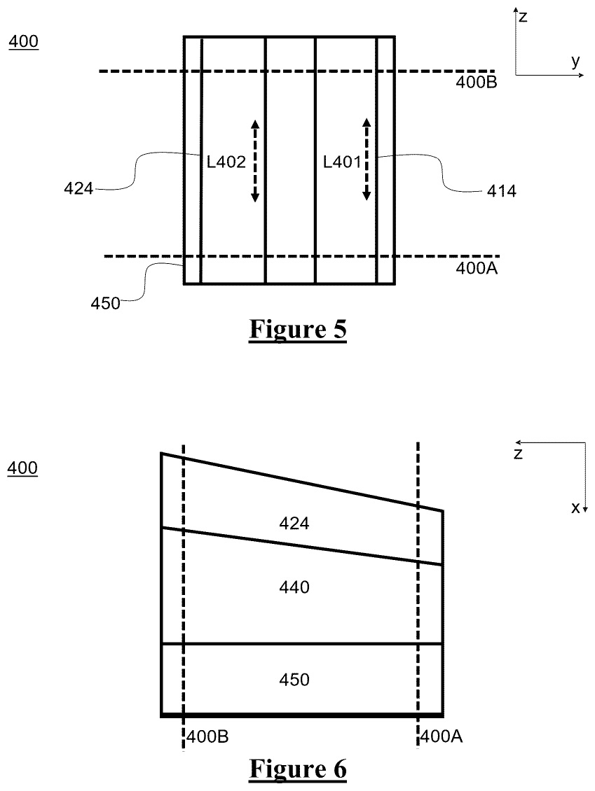

Also, a particular axis may be referred to in different examples with the axis having described properties of the axis in common. For example, the descriptions of both the examples of FIGS. 1 to 3 and of FIGS. 4 to 6 refer to an eleventh axis and a twelfth axis; in the examples of FIGS. 1 to 3, the eleventh and twelfth axes are parallel a surface of the substrate closest to the first waveguide, whereas in the examples of FIGS. 4 to 6 the eleventh and twelfth axes are perpendicular to the surface of the substrate closest to the first waveguide. As a consequence, in further examples where there is also tapering described using axes perpendicular the eleventh and twelfth axes, thirteenth and fourteenth axes are referred to with their orientation depending on the orientation of the eleventh and twelfth axes. A similar approach to labelling axes applies for other examples, where tapering of a feature such as a waveguide is described using two sets of perpendicular axes.

In examples, such as those of FIGS. 1 to 3, a first distance D101 between the first electrode and the first portion of the substrate is substantially the same (e.g. within acceptable manufacturing and/or performance tolerances) as a second distance D102 between the second electrode and the second portion of the substrate. The first distance and the second distance are each perpendicular a light propagation axis L101 (taken along a longitudinal dimension) of the first waveguide 130. A light propagation axis L102 of the second waveguide 140 is in examples parallel the light propagation axis L101 of the first waveguide 130. In some examples, the substrate 150 has a planar surface, with the first portion and the second portion of the substrate, and the planar surface, in the same two dimensional plane as each other; the first and second distances are also perpendicular the planar surface. Such first and second distances can facilitate integration of the electro-optical modulator into generic PIC platforms where it is required for all of the electrodes to be the same distance from the substrate as this allows simpler, cheaper and quicker fabrication of the PIC.

In examples, such as those illustrated in FIGS. 1 to 3, the first electrode 114 is in contact with the first waveguide 130. Similarly, the second electrode 124 is in contact with the second waveguide 140. A surface of the first waveguide in contact with the first electrode is for example substantially coplanar with a surface of the second waveguide in contact with the second electrode, as illustrated for example by FIGS. 1 to 3. A person skilled in the art will appreciate that two surfaces are substantially coplanar when both surfaces lie (within acceptable manufacturing and/or performance tolerances) in the same two-dimensional plane P100. Such coplanarity e.g. reduces the capacitance between the electrodes, to give faster modulation of the electrical potential difference between the first electrode and the second electrode. In some examples this allows 100 GHz operation and 150 Gbps non-return-to-zero (NRZ) operation; however, depending on the chosen dimensions and materials of elements of the modulator, e.g. the waveguides and electrodes, greater or lesser performance is envisaged.

In the examples such as those illustrated by FIGS. 1 to 3, a width D123 of the first electrode is greater than a width D111 of the first waveguide. Similarly, a width D112 of the second electrode is greater than a width D122 of the second waveguide. Each of the widths is perpendicular the light propagation axis L101 of the first waveguide and also perpendicular to the first distance. In some examples, a portion of at least one of the first electrode or a portion of the second electrode each extend beyond an outer surface of the first waveguide and the second waveguide respectively. In this way the portions of the electrodes can each be considered to be free-or over-hanging without the respective one of the first waveguide or the second waveguide beneath. This means that where certain dimensions and/or a volume of the first electrode and the second electrode are desired for a particular modulator performance, dimensions of the first and second waveguides for the desired modulator performance can be chosen more independently of the electrode dimensions. E.g., the electrodes can be positioned closer to or further away from each other without affecting a desired distance D5 between the first waveguide and the second waveguide.

For example, as illustrated by FIGS. 1 to 3, a longitudinal surface S101 of the first waveguide (closest to the second waveguide) is spaced from a surface S102 of the second waveguide (closest to the first waveguide) and is substantially coplanar (within acceptable manufacturing and/or performance tolerances) with a surface S103 of the first electrode (closest to the second electrode). The surface S102 of the second waveguide closest to the first waveguide is coplanar with a surface S104 of the second electrode closest to the first electrode. In this way, a spacing between the waveguides and a distance between the electrodes is the same, which can facilitate manufacture (e.g. one channel can be etched to form the inner surfaces of the electrodes and of the waveguides), but which can also simplify obtaining such inter-electrode and inter-waveguide spacings for a desired performance of the modulator.

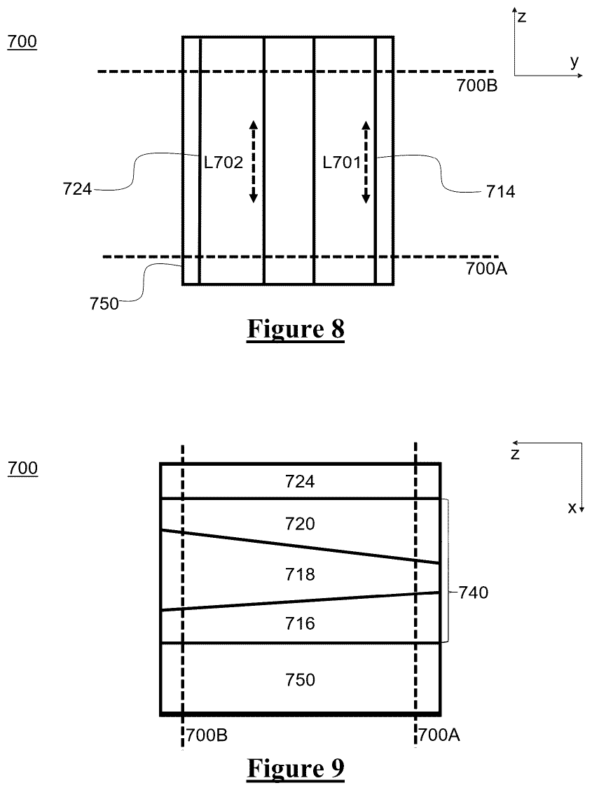

In examples, such as those of FIGS. 1 to 9, by positioning the electrodes on the waveguides, and with the waveguides having a sufficiently narrow width, a desired capacitance and inductance of the line can be obtained. Consequently, such examples give reduced microwave loss and achieve velocity matching to the optical signal with a desirable impedance match without capacitive loading. In other electro-optical modulators and methods of optical modulation, the bandwidth is constrained by high electrical loss due to the electrode designs, and the line electrical impedance magnitude is limited to 30 Ω at high frequencies which leads to undesired electrical reflections.

In the examples such as those illustrated by FIGS. 1 to 3 the first electrode is tapered so that the width D123 of the first electrode at cross section 100A (taken at plane 100A) is less than the width D141 of the first electrode at cross section 100B (taken at plane 100B). Similarly, in examples such as those of FIGS. 1 to 3, the second electrode is tapered so that the width D122 of the second electrode at cross section 100A (taken at plane 100A) is less than the width D142 of the second electrode at cross section 100B (taken at plane 100B). The width of the first electrode and the width of the second electrode are perpendicular to the light propagation axis L101 of the first waveguide and the light propagation axis L102 of the second waveguide respectively. The width of the first electrode and the width of the second electrode are perpendicular to surface S103 and surface S104 respectively.

A taper or use of the term tapered relates to the shape of an object or feature, where along one axis (e.g. a longitudinal axis or a parallel axis thereto) the object or feature has a different dimension or size (e.g. a width along an axis perpendicular to the longitudinal axis) at different locations along the longitudinal axis or parallel axis thereto. So, for example, there can be considered to be a change in a dimension or size from one plane perpendicular to and on one location on a light propagation axis to another plane perpendicular to and on another location on the light propagation axis. This change, or taper, is, for example, a stepped change in dimension or size, a gradual or linear change, or a step change, though other transitions in dimension or size are envisaged.

In examples such as those illustrated by FIGS. 1 to 3 the size, e.g. the width D123, of a first portion of the first electrode (for example a portion at plane 100A) along an axis (referred to also as the eleventh axis) is less than the size, e.g. the width D141, of a second portion (for example a portion at plane 100B) of the first electrode along an axis (referred to also as the twelfth axis), the eleventh axis parallel to the twelfth axis, the eleventh axis and twelfth axis each perpendicular to the light propagation axis L101 of the first waveguide 130, and the eleventh axis spaced from the twelfth axis along the light propagation axis of the first waveguide. In examples such as those illustrated by FIGS. 1 to 3, the eleventh axis and twelfth axis are each parallel to the surface (which is e.g. planar) of the substrate closest to the first waveguide.

In examples such as those illustrated by FIGS. 1 to 3, the second electrode size, e.g. the width D122, of a first portion (for example a portion at plane 100A) of the second electrode along an axis (referred to also as the fifteenth axis) is less than the size, e.g. the width D142, of a second portion (for example a portion at plane 100B) of the second electrode along an axis (referred to also as the sixteenth axis), the fifteenth axis and the sixteenth axis each perpendicular to the light propagation axis L102 of the second waveguide 140, and the fifteenth axis spaced from the sixteenth axis along the light propagation axis of the second waveguide. In some examples, such as those of FIGS. 1 to 3, the fifteenth axis and the sixteenth axis are each parallel to the surface (which is e.g. planar) of the substrate closest to the second waveguide.

In examples such as those illustrated by FIGS. 1 to 3 the first waveguide is tapered so that the width of the first waveguide D111 at cross section 100A (taken at plane 100A) is less than the width of the first waveguide D131 at cross section 100B (taken at plane 100B) Similarly, in examples such as those of FIGS. 1 to 3, the second waveguide is tapered so that the width of the second waveguide D112 at cross section 100A (taken at plane 100A) is less than the width of the second waveguide D132 at cross section 100B (taken at plane 100B). The width of the first waveguide and the width of the second waveguide are perpendicular to the light propagation axis L101 of the first waveguide and the light propagation axis L102 of the second waveguide respectively. The width of the first waveguide and the width of the second waveguide are perpendicular to surface S101 and surface S102 respectively.

In some examples such as those illustrated by FIGS. 1 to 3, the size, e.g. the width D111, of a first portion (for example a portion at plane 100A) of the first waveguide along an axis (referred to also as the third axis) is less than the size, e.g. the width D131, of a second portion (for example a portion at plane 100B) of the first waveguide along an axis (referred to also as the fourth axis) parallel to the third axis, the third axis and the fourth axis each perpendicular to the light propagation axis L101 of the first waveguide 130, and the third axis spaced from the fourth axis along the light propagation axis of the first waveguide. In some examples such as those illustrated by FIGS. 1 to 3, the third axis and the fourth axis each parallel to a surface (which is e.g. planar) of the substrate closest to the first waveguide.

In some examples such as those illustrated by FIGS. 1 to 3, the size, e.g. the width D112 of a first portion (for example a portion at plane 100A) of the second waveguide along an axis (referred to also as the seventh axis) is less than the size, e.g. the width D132, of a second portion (for example a portion at plane 100B) of the second waveguide along an axis (referred to as the eighth axis) parallel the seventh axis, the seventh axis and the eighth axis each perpendicular to a light propagation axis L102 of the second waveguide 140, and the seventh axis spaced from the eighth axis along the light propagation axis of the second waveguide. In some examples such as those illustrated by FIGS. 1 to 3 the seventh axis and the eighth axis are each parallel to a surface (which is e.g. planar) of the substrate closest to the second waveguide.

In examples such as those illustrated by FIGS. 1 to 3 the separation (corresponding e.g. to a gap or inter-electrode distance) between the first electrode and the second electrode is tapered, e.g. so that the separation D5 along the first axis (for example the first axis on plane 100A) between the first electrode and the second electrode, at cross section 100A (taken at plane 100A), is different from (e.g. greater than or less than) the separation D15 along the second axis (for example an axis on plane 100B) between the first electrode and the second electrode at cross section 100B (taken at plane 100B).

In examples, such as those illustrated by FIGS. 1 to 3, with tapering of the separation (corresponding e.g. to a gap or inter-electrode distance) between the first electrode and the second electrode, the electrical impedance value between the first electrode and the second electrode at locations corresponding to the input of the first waveguide and the input of the second waveguide respectively is different to the electrical impedance value between the first electrode and the second electrode at locations corresponding to the output of the first waveguide and the output of the second waveguide respectively. In some examples, tapering of the separation (corresponding e.g. to a gap or inter-electrode distance) between the first electrode and the second electrode facilitates a reduction of reflections, and increased bandwidth.

In some examples, the electrical impedance value is related to the square root of the inductance which is then divided by capacitance. In some such examples, the parallel plate capacitance of a portion of intrinsic semiconductor (e.g. as described further below) causes the greatest portion of capacitance between the first electrode and the second electrode. Therefore, reducing the waveguide width reduces the capacitance between the first electrode and the second electrode and increases the electrical impedance value. Further, or in different examples, reducing the width of one or more electrode and increasing the separation between the electrodes results in greater inductance. Therefore, reducing the electrode width and increasing the separation between the electrodes increases the impedance by increasing the capacitance.

Further examples are illustrated by FIGS. 4 to 6; features of these examples are similar to features described above and will be referred to using the same reference numeral incremented by 400 instead of 100; corresponding descriptions for such features apply here also. In examples such as those illustrated by FIGS. 4 to 6, the first electrode 414 is tapered so that the height D405 of the first electrode D405 at cross section 400A (taken at plane 400A) is less than the height D415 of the first electrode D415 at cross section 400B (taken at plane 400B) Similarly, in examples such as those of FIGS. 4 to 6, the height of the second electrode 424 is tapered so that the height D407 of the second electrode D407 at cross section 400A (taken at plane 400A) is less than the height D417 of the second electrode D417 at cross section 400B (taken at plane 400B). The height of the first electrode and the height of the second electrode are perpendicular to the light propagation axis L401 of the first waveguide 430 L401 and the light propagation axis L402 of the second waveguide 440 L402 respectively. The height of the first electrode and the height of the second electrode are parallel to surface S403 and surface S404 respectively.

In examples such as those illustrated by FIGS. 4 to 6 the size, e.g. the height D405, of a first portion of the first electrode (for example a portion at plane 400A) along an axis (referred to also as the eleventh axis) is less than the size, e.g. the height D415, of a second portion (for example a portion at plane 400B) of the first electrode along an axis (referred to also as the twelfth axis), the eleventh axis parallel to the twelfth axis, the eleventh axis and twelfth axis each perpendicular to the light propagation axis L401 of the first waveguide 430, and the eleventh axis spaced from the twelfth axis along the light propagation axis of the first waveguide. In examples such as those illustrated by FIGS. 4 to 6, the eleventh axis and twelfth axis are each perpendicular to the surface (which is e.g. planar) of the substrate closest to the first waveguide 430.

In some examples, the first electrode is tapered in two perpendicular axes. In such examples, in addition to the tapering described with the eleventh and twelfth axes, the size of the first portion of the first electrode along an axis (referred to also as the thirteenth axis) is less than the size of the second portion of the first electrode along an axis (referred to also as the fourteenth axis), the thirteenth axis parallel to the fourteenth axis, the thirteenth axis and the fourteenth axis each perpendicular to the light propagation axis of the first waveguide, the thirteenth axis and the fourteenth axis each perpendicular to the eleventh axis, and the fourteenth axis spaced from the thirteenth axis along the light propagation axis of the first waveguide.

In examples such as those illustrated by FIGS. 4 to 6, the second electrode size, e.g. the height D407, of a first portion (for example a portion at plane 400A) of the second electrode along an axis (referred to also as the fifteenth axis) is less than the size, e.g. the height D417, of a second portion (for example a portion at plane 400B) of the second electrode along an axis (referred to also as the sixteenth axis), the fifteenth axis and the sixteenth axis each perpendicular to the light propagation axis L402 of the second waveguide 440, and the fifteenth axis spaced from the sixteenth axis along the light propagation axis of the second waveguide. In some examples, such as those of FIGS. 4 to 6, the fifteenth axis and the sixteenth axis are each perpendicular to the surface of the substrate closest to the second waveguide.

In some examples, the second electrode is tapered in two perpendicular axes. In such examples, in addition to the tapering described with the fifteenth and sixteenth axes, the size, of the first portion of the second electrode along an axis (referred to also as the seventeenth axis) is less than the size of the second portion of the second electrode along an axis (referred to also as the eighteenth axis), the seventeenth axis and the eighteenth axis each perpendicular to the light propagation axis of the second waveguide, the seventeenth axis and eighteenth axis each perpendicular to the fifteenth axis, and the eighteenth axis spaced from the seventeenth axis along the light propagation axis of the second waveguide.

In examples such as those illustrated by FIGS. 4 to 6 the first waveguide 430 is tapered so that the height of the first waveguide D405 at cross section 400A (taken at plane 400A) is less than the height of the first waveguide D415 at cross section 400B taken at plane 400B. Similarly, in examples such as those of FIGS. 4 to 6, the height of the second waveguide is tapered so that the height of the second waveguide D407 at cross section 400A taken at plane 400A is less than the height of the second waveguide 417 at cross section 400B taken at plane 400B. The height of the first waveguide and the height of the second waveguide are perpendicular to the light propagation axis of the first waveguide L401 and the light propagation axis of the second waveguide L402 respectively. The height of the first waveguide and the height of the second waveguide are parallel to surface S401 and surface S402 respectively.

In some examples such as those illustrated by FIGS. 4 to 6, the size, e.g. the height D401, of a first portion (for example a portion at plane 400A) of the first waveguide along an axis (referred to also as the third axis) is less than the size, e.g. the height D451, of a second portion (for example a portion at plane 400B) of the first waveguide along an axis (referred to also as the fourth axis) parallel the third axis, the third axis and the fourth axis each perpendicular to the light propagation axis L401 of the first waveguide 430, and the third axis spaced from the fourth axis along the light propagation axis of the first waveguide. In some examples such as those illustrated by FIGS. 4 to 6, the third axis and the fourth axis are each perpendicular to a surface (which is e.g. planar) of the substrate closest to the first waveguide.

In some examples such as those illustrated by FIGS. 4 to 6, the size, e.g. the height D402 of a first portion (for example a portion at plane 400A) of the second waveguide along an axis (referred to also as the seventh axis) is less than the size, e.g. the height D452, of a second portion (for example a portion at plane 400B) of the second waveguide along an axis (referred to as the eighth axis) parallel the seventh axis, the seventh axis and the eighth axis each perpendicular to a light propagation axis L402 of the second waveguide 400, and the seventh axis spaced from the eighth axis along the light propagation axis of the second waveguide. In some examples such as those illustrated by FIGS. 4 to 6 the seventh axis and the eighth axis are each perpendicular to the surface of the substrate closest to the second waveguide.

In some examples, the first waveguide is tapered in two perpendicular axes. In such examples, in addition to tapering described with the third and fourth axes, the size, of the first portion of the first waveguide along an axis (referred to also as the fifth axis) is less than the size, of the second portion of the first waveguide along an axis (referred to also as the sixth axis) parallel to the fifth axis, the fifth axis and the sixth axis each perpendicular to the light propagation axis of the first waveguide, the fifth axis and the sixth axis each perpendicular to the third axis, and the fifth axis spaced from the sixth axis along the light propagation axis of the first waveguide. Similarly, in some examples, the second waveguide is tapered in two perpendicular axes. In such examples, in addition to tapering described with the seventh and eighth axes, the size, of the first portion of the second waveguide along an axis (referred to also as the ninth axis) is less than the size of the second portion of the second waveguide along an axis (referred to also as the tenth axis) parallel to the ninth axis, the ninth and tenth axis each perpendicular to the light propagation axis of the second waveguide, the ninth and tenth axis perpendicular to the seventh axis and eighth axis, and the ninth axis spaced from the tenth axis along the light propagation axis of the second waveguide. In examples, such as those illustrated by FIGS. 1 to 6, the first and second electrode are tapered. In some examples with tapering of at least one of the first electrode or the second electrode, the electrical impedance value between the first electrode and the second electrode at locations corresponding to the input of the first waveguide and the input of the second waveguide respectively is different to the electrical impedance value between the first electrode and the second electrode at locations corresponding to the output of the first waveguide and the output of the second waveguide respectively. In some examples, tapering of at least one of the first electrode or the second electrode facilitate a reduction of electrical reflections, and increased bandwidth.

In examples, such as those illustrated by FIGS. 1 to 6, the first and second waveguide are tapered. In some examples with tapering of at least one of the first waveguide or the second waveguide, the electrical impedance value between the first electrode and the second electrode at locations corresponding to the input of the first waveguide and the input of the second waveguide respectively is different to the electrical impedance value between the first electrode and the second electrode at locations corresponding to the output of the first waveguide and the output of the second waveguide respectively. In some examples, tapering of at least one of the first waveguide or the second waveguide facilitates a reduction of reflections, and increased bandwidth.

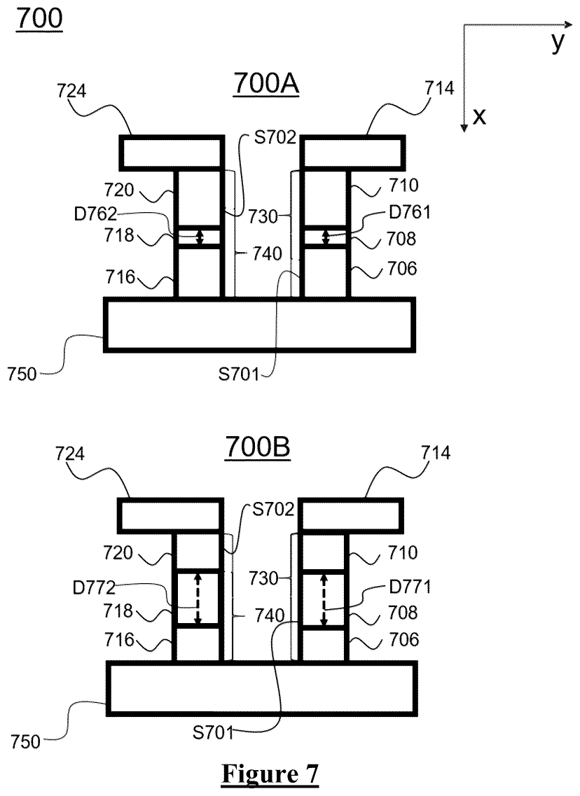

Further examples are illustrated by FIGS. 7 to 9; features of these examples are similar to features described above and will be referred to using the same reference numeral incremented by 700 instead of 100 or 400; corresponding descriptions for such features apply here also.

In examples, such as those illustrated by FIGS. 7 to 9 the first waveguide 730 comprises a portion (also referred to as the first portion), e.g. a layer, of intrinsic semiconductor 708 and the second waveguide 740 comprises a portion (also referred to as the second portion), e.g. a layer, of intrinsic semiconductor 718. In the examples such as those illustrated by FIGS. 7 to 9 the portion of intrinsic semiconductor 708 of the first waveguide is tapered so that the size, e.g. the height D761, of the portion of intrinsic semiconductor of the first waveguide at cross section 700A (taken at plane 700A) is less than the size, e.g. the height D771, of the portion of intrinsic semiconductor of the first waveguide at cross section 700B (taken at plane 700B) Similarly, the portion of intrinsic semiconductor 718 of the second waveguide is tapered so that the size, e.g. the height D762, of the portion of intrinsic semiconductor of the second waveguide at cross section 700A (taken at plane 700A) is less than the size, e.g. the height D772, of the portion of intrinsic semiconductor of the second waveguide at cross section 700B (taken at plane 700B). The size, e.g. the height, of the portion of intrinsic semiconductor of the first waveguide and the size, e.g. the height, of the portion of intrinsic semiconductor of the second waveguide are perpendicular to the light propagation axis L701 of the first waveguide and the light propagation axis L702 of the second waveguide respectively. The height of the portion of intrinsic semiconductor of the first waveguide and the height of the portion of intrinsic semiconductor of the second waveguide are for example parallel to surface S701 and surface S702 respectively.

In examples such as those illustrated by FIGS. 7 to 9, the size, e.g. the height D761, of a first portion (for example a portion at plane 700A) of the first portion of intrinsic semiconductor along an axis (referred to also as the nineteenth axis) is different to the size, e.g. the height D771, of a second portion (for example a portion at plane 700B) of the first portion of intrinsic semiconductor along an axis (referred to also as the twentieth axis), the nineteenth axis and the twentieth axis each perpendicular to the light propagation axis L701 of the first waveguide 730, and the nineteenth axis spaced from the twentieth axis along the light propagation axis of the first waveguide. In examples such as those illustrated by FIGS. 7 to 9, the nineteenth axis and the twentieth axis are each perpendicular to the surface (which is e.g. planar) of the substrate closest to the first waveguide. In other examples, the nineteenth axis and the twentieth axis are each parallel to the surface of the substrate closest to the first waveguide.

In other examples, the size of a first portion of the first portion of intrinsic semiconductor is tapered in two perpendicular axes. In such examples, in addition to tapering described in relation to the nineteenth and twentieth axes, the size of a first portion of the first portion of intrinsic semiconductor along a twenty-first axis is less than the size of the second portion of the first portion of intrinsic semiconductor along a twenty-second axis, the twenty- first axis and twenty-second axis each perpendicular to the light propagation axis of the first waveguide, the twenty-first axis and twenty-second axis each perpendicular to the twentieth axis, and the twenty-first axis spaced from the twenty-second axis along the light propagation axis of the first waveguide.

In examples such as those illustrated by FIGS. 7 to 9, the size, e.g. height D762, of a first portion (for example a portion at plane 700A) of the second portion of intrinsic semiconductor along a twenty-third axis is less than the size, e.g. height D772, of a second portion (for example a portion at plane 700B) of the second portion of intrinsic semiconductor along a twenty-fourth axis, the twenty-third axis and twenty-fourth axis each perpendicular to the light propagation axis L702 of the second waveguide 740, and the twenty-third axis spaced from the twenty-fourth axis along the light propagation axis of the second waveguide. In examples such as those illustrated by FIGS. 7 to 9, the twenty-third axis and the twenty-fourth are each perpendicular to the surface (which is e.g. planar) of the substrate closest to the second waveguide. In other examples, the twenty-third axis and the twenty-fourth axis are each parallel to the surface of the substrate closest to the second waveguide.

In other examples, the size of the first portion of the second portion of intrinsic semiconductor is tapered in two perpendicular axes. In such examples, in addition to tapering described in relation to the twenty-third and twenty-fourth axes, the size of a first portion of the first portion of intrinsic semiconductor along a twenty-fifth axis is less than the size of the second portion of the second portion of intrinsic semiconductor along a twenty-sixth axis, is the twenty-fifth axis and the twenty-sixth axis each perpendicular to the light propagation axis of the second waveguide, the twenty-fifth axis and the twenty-sixth axis each perpendicular to the twenty-fourth axis, and the twenty-fifth axis spaced from the twenty-sixth axis along the light propagation axis of the second waveguide.

In some examples, with tapering of at least one of the first portion of intrinsic semiconductor or the second portion of intrinsic semiconductor, the electrical impedance value between the first electrode and the second electrode at locations corresponding to the input of the first waveguide and the input of the second waveguide respectively is different to the electrical impedance value between the first electrode and the second electrode at locations corresponding to the output of the first waveguide and the output of the second waveguide respectively. In some examples, tapering of at least one of the first portion of intrinsic semiconductor or the second portion of intrinsic semiconductor facilitates a reduction of reflections, and increased bandwidth.

The distance between the first waveguide and the second waveguide is between 1 micrometres (μm) and 50 μm, for example. In some examples, at least one of the first waveguide or the second waveguide is between 0.5 millimetres (mm) and 5 mm in length along the respective light propagation axis. At least one of the first waveguide or the second waveguide is e.g. between 0.5 μm and 5 μm in width perpendicular to the light propagation axis. Such dimensions contribute e.g. to particular path length modulation, capacitance and/or footprint characteristics desired for the electro-optical modulator.

In some examples, at least one of the first waveguide or the second waveguide are 1 millimetre (mm) or 2 millimetre (mm) in length. In some examples: the first waveguide and the second waveguide each have a first width (schematically illustrated in FIG. 1 as D111 and D112 respectively) of 1 micro-metre (μm); the first electrode and the second electrode have a first width (schematically illustrated in FIG. 1 as D123 and D122 respectively) of 10 micro-metres (μm); a first separation between the first electrode and the second electrode (schematically illustrated in FIG. 1 as D5) is 20 micro-metres (μm); the first waveguide and the second waveguide have a second width (schematically illustrated in FIG. 1 as D131 and D132 respectively) of 1.3 micro-metres (μm); the first electrode and the second electrode have a second width (schematically illustrated in FIG. 1 as D141 and D142 respectively) of 20 micro-metres (μm); and a second separation between the first electrode and the second electrode (schematically illustrated in FIG. 1 as D15) is 10 micro-metres (μm). In some examples the input electrical impedance magnitude value is 35 Ω (Ohms) and the output electrical impedance magnitude value is 55 Ω (Ohms).

The substrate is for example a compound of elements from groups III and V of the Periodic Table, for example a so-called III-V semiconductor compound such as Indium Phosphide (InP).

In examples, the first waveguide and the second waveguide each have the same construction, and so are formed of the same materials. E.g., each of the waveguides comprise, e.g. is formed of, a stack of InP and InGaAsP. Using such a semiconductor material with a strong electro-optical effect, low electrical loss and a low optical loss can be achieved for a generic platform.

As a person skilled in the art appreciates, each electrode comprises, e.g. is formed of, a sufficiently high electrically conductive material such as Gold (Au). Other electrical conductors are envisaged in other examples, such as: Silver (Ag), Platinum (Pt), Nickel (Ni), Carbon (C), Cadmium (Cd), Tungsten (W), Aluminium (Al), or Copper (Cu).

Between the first waveguide and the second waveguide, there is for example at least one of a solid, fluid, a gas or air. This separation of the first waveguide and the second waveguide helps to reduce optical interference between the first waveguide and the second waveguide and to reduce electrical crosstalk between the first waveguide and the second waveguide.

Similarly, between the first and second electrodes, there is for example at least one of a solid, fluid, a gas or air, which may be the same fluid, gas or air as between the waveguides, and again may be the only material between the electrodes. The choice of material between the electrodes will affect the capacitance and impedance between the electrodes and allow tuning of these properties for the modulator.

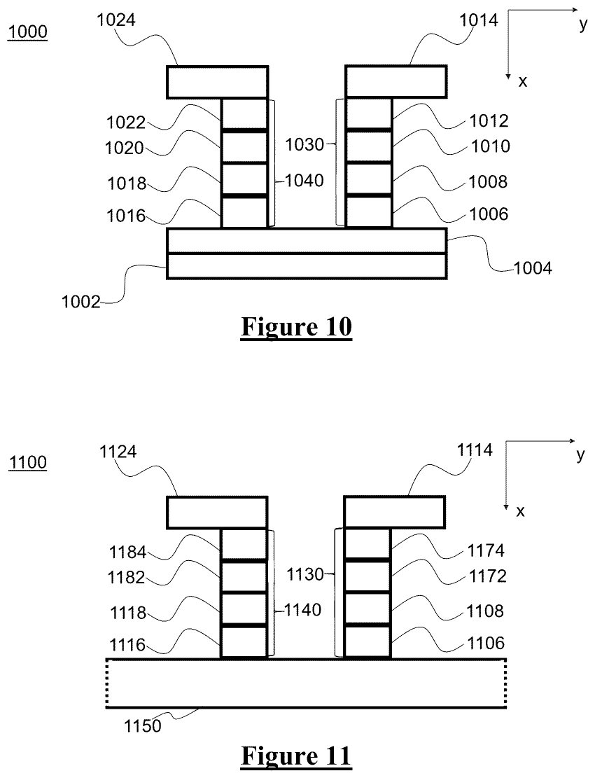

Further examples will now be described with reference to FIGS. 10 to 17. It is to be appreciated that one or both of: the waveguides, the electrodes, the separation and/or the portions of intrinsic semiconductor in such examples is tapered as described in the previous examples.

FIG. 10 illustrates examples of parts of an electro-optical modulator 1000 for a PIC. Features of these examples are similar to features described above, and will be referred to using the same reference numeral incremented by 1000 instead of 100, 400 or 700; corresponding descriptions for such features apply here also. The first waveguide 1030 comprises a first portion of n-type semiconductor 1006 in contact with the substrate; a first portion of intrinsic semiconductor 1008 on the first portion of n-type semiconductor; a first portion of a first p-type semiconductor 1010 on the first portion of intrinsic semiconductor; and a first portion of a second p-type semiconductor 1012 on the portion of the first p-type semiconductor. The first portion of a second p-type semiconductor 1012 is in contact with the first electrode 1014. The second waveguide 1040 comprises a second portion of n-type semiconductor 1016 in contact with the substrate; a second portion of intrinsic semiconductor 1018 on the second portion of n-type semiconductor; a second portion of a first p-type semiconductor 1020 on the second portion of intrinsic semiconductor; and a second portion of a second p-type semiconductor 1022 on the second portion of the first p-type semiconductor. The second portion of a second p-type semiconductor 1022 is in contact with the second electrode 1024. This structure of the first waveguide and the second waveguide each provide a vertical n-i-p-p semiconductor structure, which in some examples reduces the size of the electro-optical modulator and provides waveguides suitable for fast electro-optical modulation.

The substrate in examples such as of FIG. 10 comprises: a semi-insulator 1002; and a surface of an n-type semiconductor 1004 on a surface of a semi-insulator. The surface of an n-type semiconductor 1004 leads to simplification of integration of the electro-optical modulator 1000 into a PIC.

FIG. 11 illustrates further examples of parts of an electro-optical modulator 1100 for a PIC. Features of these examples are similar to features described above, and will be referred to using the same reference numeral incremented by 1100 instead of 100, 400, 700 or 1000; corresponding descriptions for such features apply here also. The first waveguide 1130 comprises: a first portion of a first n-type semiconductor 1106 in contact with the substrate 1150; a first portion of intrinsic semiconductor 1108 on the first portion of first n-type semiconductor; a second portion of n-type semiconductor or of a second n-type semiconductor 1172 on the first portion of intrinsic semiconductor; and a first portion of p-type semiconductor 1174 on the second portion of n-type semiconductor. The first portion of p-type semiconductor 1174 is in contact with the first electrode 1114. The second portion of n-type semiconductor 1172 in some examples is the same n-type semiconductor as the first portion of n-type semiconductor 1106, in other examples the second portion of n-type semiconductor 1172 is not the same n-type semiconductor as the first portion of n-type semiconductor 1106. The second waveguide 1140 comprises: a third portion of n-type semiconductor 1116 in contact with the substrate 1150; a second portion of intrinsic semiconductor 1118 on the third portion of n-type semiconductor; a fourth portion of n-type semiconductor 1182 on the second portion of intrinsic semiconductor; and a second portion of p-type semiconductor 1184 on the fourth portion of n-type semiconductor. The second portion of p-type semiconductor 1184 is in contact with second first electrode 1124. The fourth portion of n-type semiconductor 1182 in some examples is the same n-type semiconductor as the third portion of n-type semiconductor 1106, in other examples the fourth portion of n-type semiconductor 1182 is not the same n-type semiconductor as the first portion of n-type semiconductor 1106. This structure of the first waveguide and the second waveguide each provide a vertical (as illustrated) n-i-n-p semiconductor structure, which in some examples is for reducing the size of the electro-optical modulator and for providing waveguides suitable for fast electro-optical modulation.

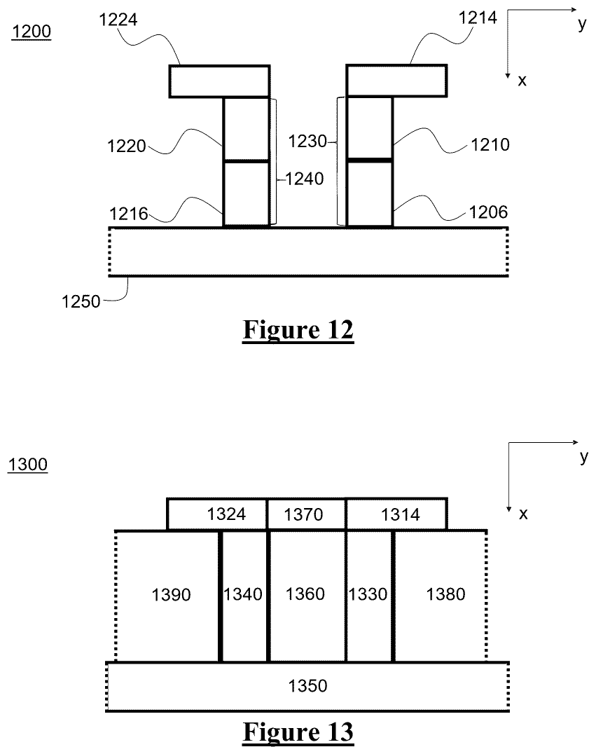

FIG. 12 illustrates other examples of parts of an electro-optical modulator 1200 for a PIC. Features of these examples are similar to features described above, and will be referred to using the same reference numeral incremented by 1200 instead of 100, 400, 700, 1000 or 1100; corresponding descriptions for such features apply here also. The first waveguide 1230 comprises: a first portion of n-type semiconductor 1206 in contact with the substrate 1250; and a first portion of a p-type semiconductor 1210 on the first portion of n-type semiconductor. The first portion of n-type semiconductor is in contact with the first electrode 1214. The second waveguide 1240 comprises: a second portion of n-type semiconductor 1216 in contact with the substrate 1250; and a second portion of a p-type semiconductor 1220 on the second portion of n-type semiconductor. The second portion of n-type semiconductor is in contact with the second electrode 1224. This structure of the first waveguide and the second waveguide each provide a vertical (as illustrated) n-p semiconductor structure, which in some examples reduces the complexity and cost of manufacture of the structure.

FIG. 13 illustrates examples of parts of an electro-optical modulator 1300 for a PIC. Features of these examples are similar to features described above, and will be referred to using the same reference numeral incremented by 1300 instead of 100, 400, 700, 1000, 1100 or 1200; corresponding descriptions for such features apply here also. FIG. 13 illustrates an example electro-optical modulator 1300 for a PIC comprising a solid dielectric material 1370 between the first electrode 1314 and the second electrode 1324, and a solid electrical insulator 1360 between the first waveguide 1330 and the second waveguide 1340. The dielectric material will affect the capacitance and impedance between the first electrode and the second electrode, and the electrical insulator will affect the optical interference between the first waveguide and the second waveguide. Each of the dielectric material and the electrical insulator therefore allow the tuning of these properties for performance of the modulator. The dielectric material is for example a poly-imide; however, other dielectric materials are envisaged. The electrical insulator is for example a solid cured polymer; however, in other examples, other solid materials may be arranged between the first waveguide 1330 and the second waveguide 1340, such as other solid dielectric materials. 1380 and 1390 are portions of material which in some examples support regions of the first and/or second electrode. In some examples 1380 and 1390 are portions of the same bulk of material. 1380 and 1390 are for example a poly-imide; however, other dielectric materials or insulators are envisaged. 1380 and 1390 for example comprise an electrical insulator and/or a solid cured polymer, other solid materials are envisaged.

FIG. 14 illustrates schematically, in accordance with examples, applying a potential difference 1494 between the substrate and at least one of the first electrode or the second electrode which allows at least one of the first waveguide or the second waveguide to be biased. FIG. 14 also illustrates applying a first potential difference or a second potential difference (depending on the magnitude in volts) 1492 between the first electrode and the second electrode. Modulating the potential difference between first electrode and the second electrode modulates, or changes, the difference between the potential difference across the first waveguide and the potential difference across the second waveguide, and therefore the difference in effective optical path length between the first waveguide and the second waveguide due to the electro-optical effect. Examples are configured in a push-pull method of modulation; however, other methods of modulation such as single drive are envisaged. As will be appreciated, features of these examples are similar to features described above, and will be referred to using the same reference numeral incremented by 1400; corresponding descriptions for such features apply here also.

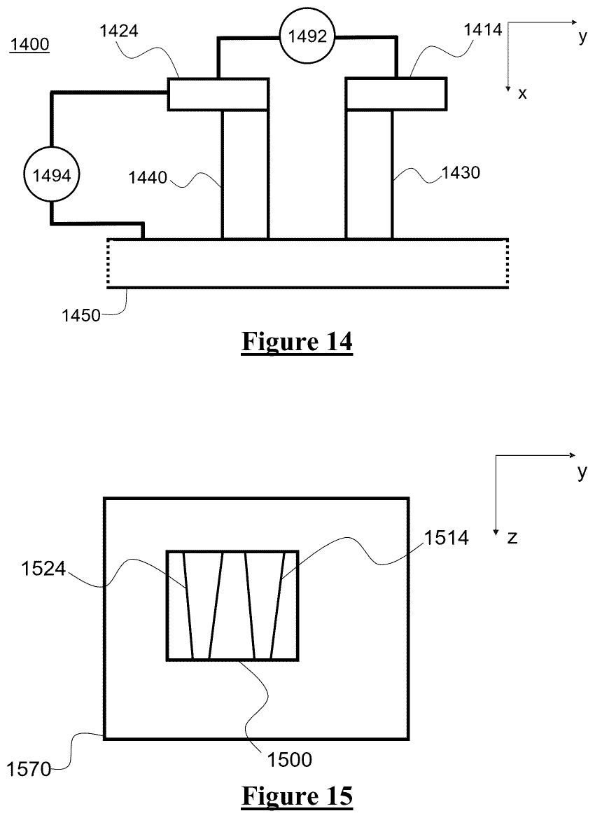

FIG. 15 illustrates schematically, in accordance with examples, a photonic integrated circuit 1570 comprising the electro-optical modulator 1500 of examples described herein. Embedding the electro-optical modulator into a generic photonic platform such as a PIC allows combination of the electro-optical modulator with other components. The PIC can be considered a monolithic PIC, with a single monolithic substrate and multiple optical components thereon. A person skilled in the art will appreciate that a PIC is often formed from a III-V semiconductor platform. Such a PIC can be fully contained without optical input or output and is sufficiently compact that it can be integrated in devices such as computers and smart phones. A semiconductor platform for use in a PIC comprises materials and is manufactured according to the intended application of the PIC. Some examples of PICs comprise a waveguide structure to allow light to propagate from one part of the PIC to another in a desired manner Some examples of PICs comprise electrical circuitry which allow external control of components of the PIC by appropriate electrical connections to electrodes or other electrical contacts on the PIC. In examples herein, and as explained further below, the first electrode 1514 and the second electrode 1524 are for electrical connection to electrical circuitry for controlling the modulation. As will be appreciated, features of these examples are similar to features described above, and will be referred to using the same reference numeral incremented by 1500; corresponding descriptions for such features apply here also.

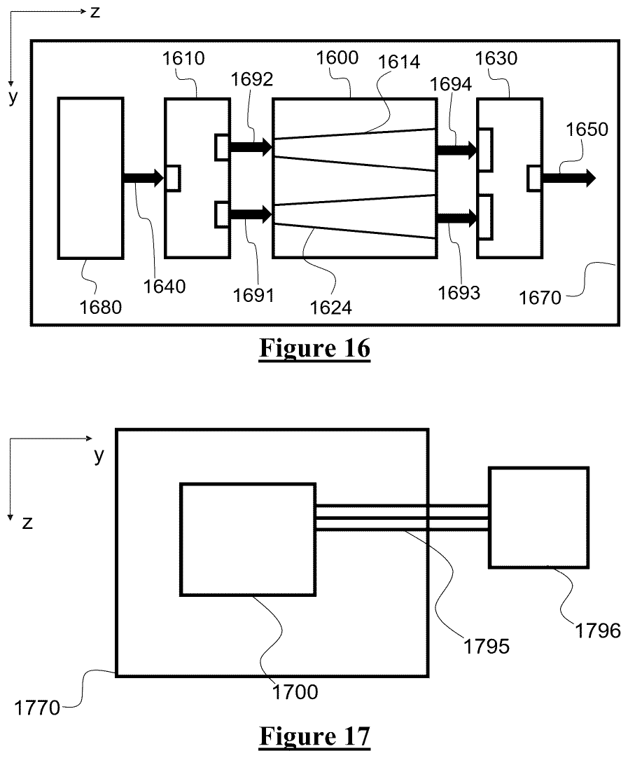

FIG. 16 illustrates examples of a PIC 1670 comprising the electro-optical modulator 1600 of examples described herein; an optical source 1680 with an optical output 1640; an optical splitter 1610 for splitting the optical output 1640 from the optical source into a first optical output 1692 and a second optical output 1691 and directing the first optical output 1692 after splitting to the first waveguide beneath the first electrode 1614 and the second optical output 1691 to the second waveguide beneath the second electrode 1624; and an optical combiner 1630 for combining light from the first waveguide 1694 and the second waveguide 1693 to produce an optical output 1650. The wavelength of the optical source is e.g. between 10 nanometres and 1 mm. In some examples, the optical source is a semiconductor laser which e.g. allows integration of the light source onto the same substrate as the electro-optical modulator. Other optical sources are envisaged as alternatives, such as: a diode, a solid-state laser, a gas laser or a lamp. The optical splitter and optical combiner e.g. comprise a 2×1 multimode interferometer; however other optical combiners and optical splitters are envisaged for further examples, such as: other multimode interferometers, beam splitters, an optical fibre coupler or an optical fibre splitter.

In examples, a connection between the optical source and the optical splitter, connections between the optical splitter and the first waveguide and the second waveguide, and a connection between the optical combiner and the first waveguide and the second waveguide, are achieved in different ways in different examples. In some examples these connections are achieved with waveguides; however, in other examples, other connections are envisaged, such as free-space propagation, and optical fibre connections. In some examples a tapered waveguide connects: the optical source and the optical splitter, the optical splitter and the first waveguide and the second waveguide, or the optical combiner and the first waveguide and the second waveguide.

Some examples comprise electrical insulator between the first electrode and the optical source. This allows reduced electrical interference between the first electrode and the optical source. An electrical insulator portion e.g. has a sufficiently low electrical conductivity to sufficiently reduce cross-talk between the electrode and the source.

FIG. 17 schematically illustrates examples of a system for electro-optical modulation comprising: the PIC as previously described 1770; and a controller 1796 configured to: apply the potential difference between the substrate and at least one of the first electrode or the second electrode, and to switch between applying the first potential difference and applying the second potential difference between the first electrode and the second electrode. A controller may be or comprise an electrical source or driver, to apply a direct current (DC) and/or alternating current (AC) potential difference. The PIC comprises the parts of the electro-optical modulator 1700 and electrical connections 1795 connected to the first and second electrodes and the controller. In some examples the difference in volts between the first potential difference and the second potential difference is such that light propagating through the first waveguide is shifted in phase from light propagating through the second waveguide by 180°.

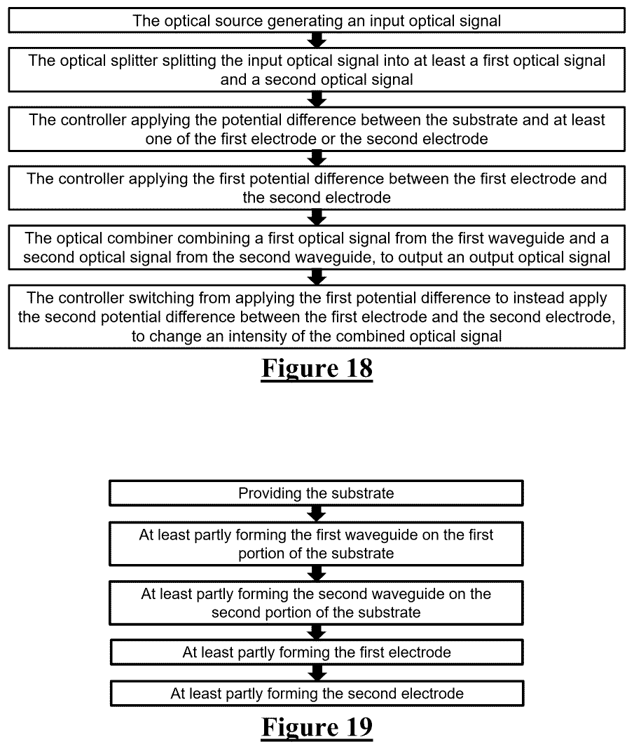

FIG. 18 schematically illustrates a method of modulating an optical signal in accordance with examples: the optical source generating an input optical signal; the optical splitter splitting the input optical signal into at least a first optical signal and a second optical signal; the controller applying the potential difference between the substrate and at least one of the first electrode or the second electrode; the controller applying the first potential difference between the first electrode and the second electrode; the optical combiner combining a first optical signal from the first waveguide and a second optical signal from the second waveguide, to output an output optical signal; and the controller switching from applying the first potential difference to instead apply the second potential difference between the first electrode and the second electrode, to change an intensity of the combined optical signal.

FIG. 19 schematically illustrates a method of manufacturing an electro-optical modulator in accordance with examples, comprising: providing the substrate; at least partly forming the first waveguide on the first portion of the substrate; at least partly forming the second waveguide on the second portion of the substrate; at least partly forming the first electrode; and at least partly forming the second electrode. Examples of techniques for at least partially forming a substrate, a waveguide, a portion of semiconductor or an electrode are: metalorganic vapour-phase epitaxy, surface passivation, photolithography, ion implantation, etching, dry etching, ion etching, wet etching, buffered oxide etching, plasma ashing, thermal treatment, annealing, thermal oxidation, chemical vapor deposition, atomic layer deposition, physical vapor deposition, molecular beam epitaxy, laser lift-off, electrochemical deposition, electroplating, or chemical-mechanical polishing. In some examples etching techniques are used to remove portions of material, as part of patterning, as the skilled person will appreciate. In some examples the substrate is a monolith for a PIC comprising the electro-optical modulator, which allows integration of the electro-optical modulator into more complex circuits.

The above examples are to be understood as illustrative examples of the invention. Further examples of the invention are envisaged. For example, the semiconductors, semi-insulators and insulators described herein may be at least one of Indium Phosphide (InP), Gallium Arsenide (GaAs), Gallium Antimonide (GaSb), Gallium Nitride (GaN), Indium Gallium Arsenide (InGaAs), Indium Aluminium Arsenide (InAlAs), Aluminium GallliumIndium Aluminium Gallium Arsenide (InAlGaAs), Indium Gallium Arsenide Phosphide (InGaAsP), Silicon (Si), Silicon Nitride (Si₃N₄), or Silicon Oxide (SiO₂); however, other semiconductor, semi-insulator and insulator materials are envisaged.

Further examples of an electro-optical modulator in accordance with the appended claims are envisaged. For example, in addition to the first and second electrodes, the electro-optical modulator comprises a third electrode which in some examples is tapered, e.g. similar to a tapering of the first electrode as described above. The third electrode is on and/or in contact with at least one of: the first waveguide, the second waveguide or the substrate. In some examples the first electrode is not in contact with the first waveguide and/or the second electrode is not in contact with the second waveguide. In some examples at least one of the first electrode or the second electrode is on, e.g. in contact with, the substrate. In further examples at least one of the first electrode, second electrode or third electrode is in contact with both the first waveguide and the second waveguide.

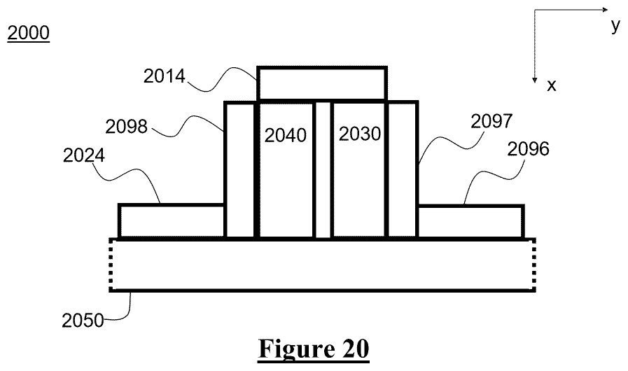

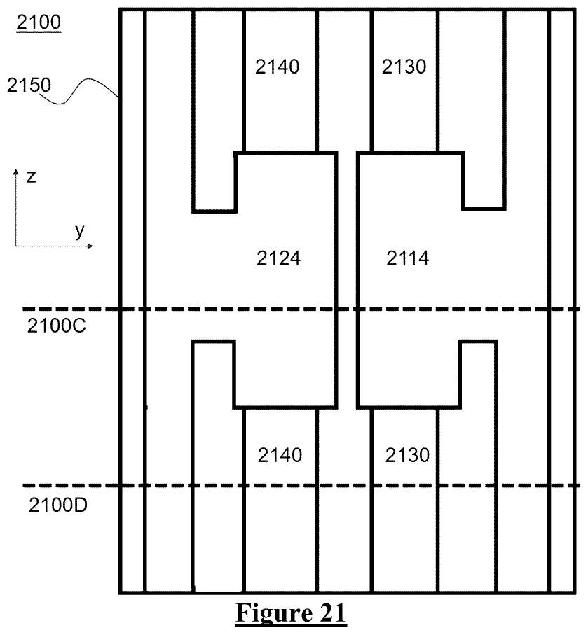

FIG. 20 illustrates in cross section an electro-optical modulator 2000 for a PIC of examples. Features of these examples are similar to features described above, and will be referred to using the same reference numeral incremented by 2000 instead of 100, 400, 700, 1000, 1100, 1200, 1300 or 1500. Examples such as those illustrated in FIG. 20 comprise a first electrode 2014 on and in contact with the first waveguide 2030 and the second waveguide 2040. Both the second electrode 2024 and the third electrode 2096 are on and in contact with the substrate. Portions of polyimide 2097 and 2098 may be present between the first waveguide and the third electrode, and between the second waveguide and the second electrode, as for example shown in FIG. 20.

FIG. 21 illustrates in plan view an electro-optical modulator 2100 for a PIC of examples. Features of these examples are similar to features described above, and will be referred to using the same reference numeral incremented by 2100 instead of 100, 400, 700, 1000, 1100, 1200, 1300 1500 or 2000. Examples such as those illustrated in FIG. 21 are configured with the modulator having at least one capacitively loaded portion (e.g. a portion at plane 2100C perpendicular the light propagation axis of the first waveguide) and at least one capacitively unloaded portion (e.g. a portion at plane 2100D perpendicular the light propagation axis of the first waveguide).

It is to be appreciated that in some examples, a third electrical impedance value between the first electrode and the second electrode is not different from at least one of the first electrical impedance value and the second electrical impedance value. The third electrical impedance value is along a further axis perpendicular a light propagation axis of the first waveguide and parallel to and spaced from the other axes (e.g. the first axis and second axis) along the light propagation axis of the first waveguide which electrical impedance values are taken. In some examples this non-change in electrical impedance value along the light propagation axis can be achieved by part of a feature such as an electrode, waveguide, intrinsic semiconductor portion or inter-electrode separation being tapered, with another part of the feature not being tapered. So, for example, a middle part of a waveguide or electrode is not tapered, rather than the feature being tapered along its entire length as is the case for other examples.

Various examples are described herein with one or more features, such as a waveguide, electrode, portion of a waveguide or a separation, which taper and/or have a difference in electrical impedance value at different locations relative to a light propagation axis. It is to be appreciated that i) a particular combination of tapered features (e.g. one or more electrode and one or more waveguide), ii) a particular magnitude of difference between electrical impedance values (in other words an extent of change of electrical impedance value) between different locations along or relative to the light propagation axis, iii) whether such a difference increases or decreases towards an output of the electro-optical modulator, and/or iv) an extent and/or direction of taper (e.g. a direction in which a width, height or separation increases or decreases), for each feature independently, depends on the particular design requirements for the PIC in question. For example, in some design circumstances, an electro-optical modulator with both electrodes tapered, both waveguides tapered, and possibly also the separation and/or portion of intrinsic semiconductor tapered too, gives a preferred change in electrical impedance value between the input and output of the electro-optical modulator. In other examples, it may be preferred to taper the electrodes but not the waveguides. It is envisaged that one or more tapered feature described herein can be used in different types of electro-optical modulator, such as a single phase modulator, a co-planar stripline electrode (CPS) modulator, a co-planar waveguide (CPW) modulator or a capacitively loaded modulator, which in some examples are used in an MZM configuration. Hence, it can be appreciated that examples described herein give a designer of an electro-optical modulator, and hence also a PIC, additional degrees of freedom and versatility to provide an electro-optical modulator with a desired performance, especially for a generic platform with prescribed dimensions for PIC design.

It is to be understood that any feature described in relation to any one example may be used alone, or in combination with other features described, and may also be used in combination with one or more features of any other of the example, or any combination of any other of the examples. Furthermore, equivalents and modifications not described above may also be employed without departing from the scope of the accompanying claims.

What is claimed is:

1. An electro-optical modulator for a photonic integrated circuit, comprising:
a substrate;
a first waveguide on a first portion of the substrate;
a first electrode;
a second waveguide on a second portion of the substrate; and
a second electrode,
wherein a first electrical impedance value between the first electrode and the second electrode is different from a second electrical impedance value between the first electrode and the second electrode, the first electrical impedance value along a first axis perpendicular a light propagation axis of the first waveguide, and the second electrical impedance value along a second axis perpendicular the light propagation axis of the first waveguide, the first axis spaced from the second axis along the light propagation axis of the first waveguide.

2. The electro-optical modulator of claim 1, wherein the first waveguide comprises:
an optical input; and
an optical output,
and the second waveguide comprises:
an optical input; and
an optical output,
wherein the first electrical impedance value is between a portion of the first electrode corresponding to the optical input of the first waveguide and a portion of the second electrode corresponding to the optical input of the second waveguide, and the second electrical impedance value is between a portion of the first electrode corresponding to the optical output of the first waveguide and a portion of the second electrode corresponding to the optical output of the second waveguide.

3. The electro-optical modulator of claim 2, wherein:
i) the portion of the first electrode corresponding to the optical input of the first waveguide and the portion of the second electrode corresponding to the optical input of the second waveguide are opposed electrode surfaces; or
ii) the portion of the first electrode corresponding to the optical output of the first waveguide and the portion of the second electrode corresponding to the optical output of the second waveguide are opposed electrode surfaces.

4. The electro-optical modulator of claim 1, wherein at least one of:
i) the magnitude of the first electrical impedance value is different to the magnitude of the second electrical impedance value;
ii) the first electrical impedance value is greater than or less than the second electrical impedance value;
iii) the first waveguide is tapered;
iv) the second waveguide is tapered;
v) the first electrode is tapered;
vi) the second electrode is tapered;
vii) a first separation, along the first axis, between the first electrode and the second electrode is
different from,
less than, or
greater than
a second separation, along the second axis, between the first electrode and the second electrode;
viii) the first waveguide comprises a first portion of intrinsic semiconductor, and the first portion of intrinsic semiconductor is tapered;
ix) the second waveguide comprises a second portion of intrinsic semiconductor, and the second portion of intrinsic semiconductor is tapered;
x) the substrate comprises a semi-insulator layer, and an n-type semiconductor layer on the semi-insulator layer;
xi) the first electrode is on at least one of the first waveguide or the substrate;
xii) the first electrode is in contact with at least one of the first waveguide or the substrate;
xiii) the second electrode is on at least one of the second waveguide or the substrate;
xiv) the second electrode is in contact with at least one of the second waveguide or the substrate; or
xv) the electro-optical modulator comprises a third electrode.

5. The electro-optical modulator of claim 1, wherein the first waveguide is tapered, and at least one of:
i) the size of a first portion of the first waveguide along a third axis is less than the size of a second portion of the first waveguide along a fourth axis parallel the third axis, the third axis and the fourth axis each perpendicular to the light propagation axis of the first waveguide, and the third axis spaced from the fourth axis along the light propagation axis of the first waveguide;
ii) the third axis and the fourth axis are each parallel to a surface of the substrate closest to the first waveguide;
iii) the third axis and the fourth axis each perpendicular to the surface of the substrate closest to the first waveguide; or
iv) the size of the first portion of the first waveguide along a fifth axis is less than the size of the second portion of the first waveguide along a sixth axis parallel to the fifth axis, the fifth axis and the sixth axis each perpendicular to the light propagation axis of the first waveguide, the fifth axis and the sixth axis each perpendicular to the third axis, and the fifth axis spaced from the sixth axis along the light propagation axis of the first waveguide.

6. The electro-optical modulator of claim 1, wherein the second waveguide is tapered and at least one of:
i) the size of a first portion of the second waveguide along a seventh axis is less than the size of a second portion of the second waveguide along an eighth axis parallel to the eighth axis, the seventh axis and the eighth axis each perpendicular to a light propagation axis of the second waveguide, and the seventh axis spaced from the eighth axis along the light propagation axis of the second waveguide;
ii) the seventh axis and the eighth axis are each parallel to a surface of the substrate closest to the second waveguide;
iii) the seventh axis and the eighth axis are each perpendicular to the surface of the substrate closest to the second waveguide; or
iv) the size of the first portion of the second waveguide along a ninth axis is less than the size of the second portion of the second waveguide along a tenth axis parallel to the ninth axis, the ninth and tenth axis each perpendicular to the light propagation axis of the second waveguide, the ninth and tenth axis perpendicular to the seventh axis and eighth axis, and the ninth axis spaced from the tenth axis along the light propagation axis of the second waveguide.

7. The electro-optical modulator of claim 1, wherein the first electrode is tapered, and at least one of:
i) the size of a first portion of the first electrode along an eleventh axis is less than the size of a second portion of the first electrode along a twelfth axis parallel to the eleventh axis, the eleventh axis and the twelfth axis each perpendicular to the light propagation axis of the first waveguide, and the eleventh axis spaced from the twelfth axis along the light propagation axis of the first waveguide;
ii) the eleventh axis and the twelfth axis are each parallel to a surface of the substrate closest to the first waveguide;
iii) the eleventh axis and the twelfth axis are each perpendicular to the surface of the substrate closest to the first waveguide; or
iv) the size of the first portion of the first electrode along a thirteenth axis is less than the size of the second portion of the first electrode along a fourteenth axis, the thirteenth axis parallel to the fourteenth axis, the thirteenth axis and the fourteenth axis each perpendicular to the light propagation axis of the first waveguide, the thirteenth axis and the fourteenth axis each perpendicular to the eleventh axis, and the fourteenth axis spaced from the thirteenth axis along the light propagation axis of the first waveguide.

8. The electro-optical modulator of claim 1, wherein the second electrode is tapered, and at least one of:
i) the size of a first portion of the second electrode along a fifteenth axis is less than the size of a second portion of the second electrode along a sixteenth axis, the fifteenth axis and the sixteenth axis each perpendicular to the light propagation axis of the second waveguide, and the fifteenth axis spaced from the sixteenth axis along the light propagation axis of the second waveguide;
ii) the fifteenth axis and the sixteenth axis are each parallel to a surface of the substrate closest to the second waveguide;
iii) the fifteenth axis and the sixteenth axis are each perpendicular to the surface of the substrate closest to the second waveguide; or
iv) the size of the first portion of the second electrode along a seventeenth axis is less than the size of the second portion of the second electrode along an eighteenth axis, the seventeenth axis and the eighteenth axis each perpendicular to the light propagation axis of the second waveguide, the seventeenth axis and the eighteenth axis each perpendicular to the fifteenth axis, and the eighteenth axis spaced from the seventeenth axis along the light propagation axis of the second waveguide.

9. The electro-optical modulator of claim 1, wherein the first waveguide comprises a first portion of intrinsic semiconductor, and:
i) a first portion of n-type semiconductor in contact with the substrate, the first portion of intrinsic semiconductor on the first portion of n-type semiconductor, a first portion of a first p-type semiconductor on the first portion of intrinsic semiconductor, and a first portion of a second p-type semiconductor on the first portion of the first p-type semiconductor;
ii) a first portion of n-type semiconductor in contact with the substrate, the first portion of intrinsic semiconductor on the first portion of n-type semiconductor, a second portion of n-type semiconductor on the first portion of intrinsic semiconductor, and a first portion of p-type semiconductor on the second portion of the first n-type semiconductor or of a second n-type semiconductor; or
iii) the first waveguide comprises a portion of n-type semiconductor in contact with the substrate, and a portion of p-type semiconductor on the portion of n-type semiconductor.

10. The electro-optical modulator of claim 9, wherein the first portion of intrinsic semiconductor is tapered, and at least one of:
i) the size of a first portion of the first portion of intrinsic semiconductor along a nineteenth axis is different to the size of a second portion of the first portion of intrinsic semiconductor along a twentieth axis parallel the nineteenth axis, the nineteenth axis and the twentieth axis each perpendicular to the light propagation axis of the first waveguide, and the nineteenth axis spaced from the twentieth axis along the light propagation axis of the first waveguide.
ii) the nineteenth axis and the twentieth axis are each parallel to a surface of the substrate closest to the first waveguide;
iii) the nineteenth axis and the twentieth axis are each perpendicular to the surface of the substrate closest to the first waveguide; or
iv) the size of the first portion of the first portion of intrinsic semiconductor along a twenty-first axis is less than the size of the second portion of the first portion of intrinsic semiconductor along a twenty-second axis parallel to the twenty-first axis, the twenty-first axis and twenty-second axis each perpendicular to the light propagation axis of the first waveguide, the twenty-first axis and twenty-second axis each perpendicular to the twentieth axis, and the twenty-first axis spaced from the twenty-second axis along the light propagation axis of the first waveguide.

11. The electro-optical modulator of claim 1, wherein the second waveguide comprises a second portion of intrinsic semiconductor, and
i) a third portion of n-type semiconductor in contact with the substrate, the second portion of intrinsic semiconductor on the third portion of n-type semiconductor, a second portion of the first p-type semiconductor on the second portion of intrinsic semiconductor, and a second portion of the second p-type semiconductor on the second portion of the first p-type semiconductor;
ii) a third portion of n-type semiconductor in contact with the substrate, the second portion of intrinsic semiconductor on the third portion of n-type semiconductor, a fourth portion of n-type semiconductor on the second portion of intrinsic semiconductor, and a second portion of p-type semiconductor on the second portion of the n-type semiconductor; or
iii) a portion of n-type semiconductor in contact with the substrate; and a portion of p-type semiconductor on the portion of n-type semiconductor.

12. The electro-optical modulator of claim 11, wherein the second layer of intrinsic semiconductor is tapered, and at least one of:
i) the size of a first portion of the second portion of intrinsic semiconductor along a twenty-third axis is less than the size of a second portion of the second portion of intrinsic semiconductor along a twenty-fourth axis parallel to the twenty-third axis, the twenty-third axis and the twenty-fourth axis each perpendicular to the light propagation axis of the second waveguide, and the twenty-third axis spaced from the twenty-fourth axis along the light propagation axis of the second waveguide;
ii) the twenty-third axis and the twenty-fourth axis are each parallel to a surface of the substrate closest to the second waveguide;
iii) the twenty-third axis and the twenty-fourth are each perpendicular to the surface of the substrate closest to the second waveguide; or
iv) the size of the first portion of the second portion of intrinsic semiconductor along a twenty-fifth axis is less than the size of the second portion of the second portion of intrinsic semiconductor along a twenty-sixth axis parallel to the twenty-fifth axis, the twenty-fifth axis and the twenty-sixth axis each perpendicular to the light propagation axis of the second waveguide, the twenty-fifth axis and the twenty-sixth axis each perpendicular to the twenty-fourth axis, and the twenty-fifth axis spaced from the twenty-sixth axis along the light propagation axis of the second waveguide.

13. The electro-optical modulator of claim 1, comprising a third electrode, and wherein at least one of:
i) the third electrode is on at least one of the first waveguide, the second waveguide or the substrate;
ii) the third electrode is in contact with at least one of the first waveguide, the second waveguide or the substrate;
iii) at least one of the first electrode, second electrode or third electrode is in contact with the first waveguide and the second waveguide; or
iv) the third electrode is tapered.

14. The electro-optical modulator of claim 1, wherein at least one of:
i) a surface of the first waveguide in contact with the first electrode is substantially coplanar with a surface of the second waveguide in contact with the second electrode;
ii) the first waveguide is between the first electrode and the first portion of the substrate;
iii) the second waveguide is between the second electrode and the second portion of the substrate;
iv) a first distance between the first electrode and the first portion of the substrate is substantially the same as a second distance between the second electrode and the second portion of the substrate, the first distance and the second distance each perpendicular a light propagation axis of the first waveguide;
v) the electro-optical modulator comprises an electrical insulator between the first waveguide and the second waveguide;
vi) the electro-optical modulator comprises at least one of a fluid, a gas or air between the first waveguide and the second waveguide;
vii) the first waveguide is spaced from the second waveguide by between 1 μm and 50 μm;
viii) a length of at least one of the first waveguide and the second waveguide is between 0.5 mm and 5 mm along the light propagation axis of the first waveguide and the second waveguide respectively;
ix) the first waveguide is between 0.5 μm and 5 μm in width taken perpendicular to the light propagation axis and perpendicular to a distance between the first electrode and the first portion of the substrate;
x) at least one of the first waveguide or the second waveguide comprises InP;
xi) at least one of the first electrode or the second electrode comprises gold; or
xii) the electro-optical modulator comprises a dielectric material between the first electrode and the second electrode.

15. A photonic integrated circuit comprising an electro-optical modulator comprising:
a substrate;
a first waveguide on a first portion of the substrate;
a first electrode;
a second waveguide on a second portion of the substrate; and
a second electrode,
wherein a first electrical impedance value between the first electrode and the second electrode is different from a second electrical impedance value between the first electrode and the second electrode, the first electrical impedance value along a first axis perpendicular a light propagation axis of the first waveguide, and the second electrical impedance value along a second axis perpendicular the light propagation axis of the first waveguide, the first axis spaced from the second axis along the light propagation axis of the first waveguide.

16. The photonic integrated circuit of claim 15, wherein at least one of:
i) the photonic integrated circuit is configured to apply a potential difference between the substrate and at least one of the first electrode or the second electrode;
ii) the photonic integrated circuit is configured to apply a first potential difference or a second potential difference between the first electrode and the second electrode; or
iii) the photonic integrated circuit comprises electrical insulator between the first electrode and the optical source.

17. The photonic integrated circuit of claim 15, comprising:
an optical source;
an optical splitter for splitting light from the optical source and directing the light after splitting to the first waveguide and the second waveguide; and
an optical combiner for combining light from the first waveguide and the second waveguide.

18. The photonic integrated circuit of claim 17, wherein the optical source is a semiconductor laser.

19. A system for electro-optical modulation comprising:
a photonic integrated circuit comprising an electro-optical modulator comprising
a substrate,
a first waveguide on a first portion of the substrate,
a first electrode,
a second waveguide on a second portion of the substrate, and
a second electrode,
wherein a first electrical impedance value between the first electrode and the second electrode is different from a second electrical impedance value between the first electrode and the second electrode, the first electrical impedance value along a first axis perpendicular a light propagation axis of the first waveguide, and the second electrical impedance value along a second axis perpendicular the light propagation axis of the first waveguide, the first axis spaced from the second axis along the light propagation axis of the first waveguide; and
a controller configured to:
apply a potential difference between the substrate and at least one of the first electrode or the second electrode, and
switch between applying the first potential difference and applying the second potential difference between the first electrode and the second electrode.

20. The system for electro-optical modulation of claim 19, a difference in volts between the first potential difference and the second potential difference such that light propagating through the first waveguide is shifted in phase from light propagating through the second waveguide by 180°.
